(19) United States
(12) Patent Application Publication
(10) Pub. No.: US 2024/0421524 A1
(43) Pub. Date: Dec. 19, 2024

(54) CONNECTOR

(71) Applicant: SUMITOMO WIRING SYSTEMS, LTD., Mie (JP)

(72) Inventor: Takahiro TSUCHIYA, Mie (JP)

(21) Appl. No.: 18/679,760

(22) Filed: May 31, 2024

(30) Foreign Application Priority Data
Jun. 13, 2023 (JP) 2023-096707

(51) Int. Cl. H01R 13/436; H01R 13/422

(52) U.S. Cl. CPC H01R 13/4362; H01R 13/4223

(57) ABSTRACT

A retainer includes a retainer body to be arranged inside the body mounting portion, a front mask portion to be arranged to cover the front surface portion and a coupling portion coupling the retainer body and the front mask portion. The retainer body includes a body end part having a projection amount from the end surface portion reduced from a temporary locking position to a complete locking position and a retaining portion for locking a terminal fitting at the complete locking position. The body end part is arranged inside the housing at the complete locking position. The front mask portion includes a recess for allowing a front surface of the body end part to be open forward at a halfway position.

### CROSS-REFERENCE TO RELATED APPLICATIONS

This application is based on and claims priority from Japanese Patent Application No. 2023-096707, filed on Jun. 13, 2023, with the Japan Patent Office, the disclosure of which is incorporated herein in its entirety by reference.

### TECHNICAL FIELD

The present disclosure relates to a connector.

### BACKGROUND

A connector disclosed in Japanese Patent Laid-open Publication No. 2012-129111 is provided with a housing for accommodating terminal fittings and a retainer, which is a front mask integrated retainer, to be mounted into the housing movably between a temporary locking position and a complete locking position. The retainer includes a front mask portion for covering the front surface of the housing, a retainer portion arranged behind the front mask portion and a pair of side plates coupling the retainer portion and the front mask portion and facing in a width. The retainer portion locks the terminal fittings at the complete locking position to restrict the terminal fittings from coming out from the housing.

However, if the terminal fitting is left at an incompletely inserted position with respect to the housing without being inserted to a specified insertion position, the retainer interferes with the terminal fitting and a movement of the retainer from the temporary locking position to the complete locking position is hindered. As a result, each of the front mask portion and the retainer portion partially projects from the lower surface of the housing. Thus, it can be detected that the terminal fitting is left at the incompletely inserted position by confirming a projecting state of the retainer visually or using a jig or the like.

Japanese Patent Laid-open Publication No. 2000-315546 discloses a retainer in which a front cover corresponding to the front mask portion and a spacer corresponding to the retainer portion are coupled by a coupling body of a flexible hinge.

### SUMMARY

In Japanese Patent Laid-open Publication No. 2012-129111, if the terminal fitting is left at an incompletely inserted position with respect to the housing when the connector is small in size, a projection amount of the retainer from the housing is small and it is difficult to confirm the projecting state of the retainer visually or using a jig or the like.

As shown in a first reference example of FIG. 13, if a front mask portion 700 and a retainer portion 300 are, for example, constituted by separate members, only the retainer portion 300 projects from the lower surface of a housing 400 when a terminal fitting 200 is at an incompletely inserted position. An inspection slider 80 configured to move along the lower surface of the housing 400 can be brought into contact with this projecting part of the retainer portion 300. If the inspection slider 80 contacts the projecting part of the retainer portion 300, it can be judged that a retainer 600 has not reached a complete locking position and, consequently, it can be detected that the terminal fitting 200 is left at the incompletely inserted position. That is, it can be detected that the terminal fitting 200 is left at the incompletely inserted position by a detection method using the inspection slider 80 (hereinafter, this detection is referred to as “terminal incomplete insertion detection by the inspection slider 80”). However, in the case of Japanese Patent Laid-open Publication No. 2012-129111, the front mask portion and the retainer portion are integrated in the retainer. If the retainer is of the integrated type, the front mask portion 700 also projects from the lower surface of the housing 400 together with the retainer portion 300 when the terminal fitting 200 is at the incompletely inserted position as shown in a second reference example (not a structure disclosed in Japanese Patent Laid-open Publication No. 2012-129111) of FIG. 14. Then, as indicated by an arrow of FIG. 14, the inspection slider 80 is separated from the lower surface of the housing 400 and moves along the lower surface of each of the front mask portion 700 and the retainer portion 300. Thus, the inspection slider 80 does not contact the projecting part of the retainer portion 300 and the terminal incomplete insertion detection by the inspection slider 80 cannot be performed.

Accordingly, the present disclosure aims to provide a connector capable of accurately performing terminal incomplete insertion detection by an inspection slider in a connector provided with a front mask integrated retainer.

The present disclosure is directed to a connector with a terminal fitting to be connected to an end part of a wire, a housing for accommodating the terminal fitting and a retainer to be arranged movably between a temporary locking position and a complete locking position with respect to the housing, the housing including a front surface portion facing forward, an end surface portion arranged to intersect the front surface portion and a body mounting portion extending inside the housing and open in the end surface portion, the retainer including a retainer body to be arranged inside the body mounting portion, a front mask portion to be arranged to cover the front surface portion and a coupling portion coupling the retainer body and the front mask portion, the retainer body including a body end part having a projection amount from the end surface portion reduced from the temporary locking position to the complete locking position and a retaining portion for locking the terminal fitting at the complete locking position, the body end part being arranged inside the housing at the complete locking position, and the front mask portion including a recess for allowing a front surface of the body end part to be open forward at the temporary locking position or a halfway position between the temporary locking position and the complete locking position.

According to the present disclosure, it is possible to provide a connector capable of accurately performing terminal incomplete insertion detection by an inspection slider in a connector provided with a front mask integrated retainer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front view showing a state where a retainer is at a complete locking position in a connector according to one embodiment of the present disclosure.

FIG. 2 is a side view showing the state where the retainer is at the complete locking position in the connector according to the embodiment.

FIG. 3 is a side view in section showing the state where the retainer is at the complete locking position in the connector according to the embodiment.

FIG. 4 is a transverse section showing a state where the retainer is locked to a housing at a temporary locking position in the connector according to the embodiment.

FIG. 5 is a side view in section showing a state where the retainer is at the temporary locking position in the connector according to the embodiment.

FIG. 6 is a perspective view of the housing in the connector according to the embodiment.

FIG. 7 is a side view of the housing in the connector according to the embodiment.

FIG. 8 is a perspective view of the retainer in the connector according to the embodiment.

FIG. 9 is a perspective view of the retainer in the connector according to the embodiment when viewed from a direction different from that of FIG. 8.

FIG. 10 is a front view of the retainer in the connector according to the embodiment.

FIG. 11 is a side view in section showing a state where an inspection slider interferes with a body end part of a retainer body through a recess of a front mask portion and performs terminal incomplete insertion detection in the connector according to the embodiment.

FIG. 12 is a bottom view showing the state where the inspection slider interferes with the body end part of the retainer body through the recess of the front mask portion and performs the terminal incomplete insertion detection in the connector according to the embodiment.

FIG. 13 is a side view in section showing a state where an inspection slider interferes with a projecting part of a retainer body and performs terminal incomplete insertion detection in a first reference example.

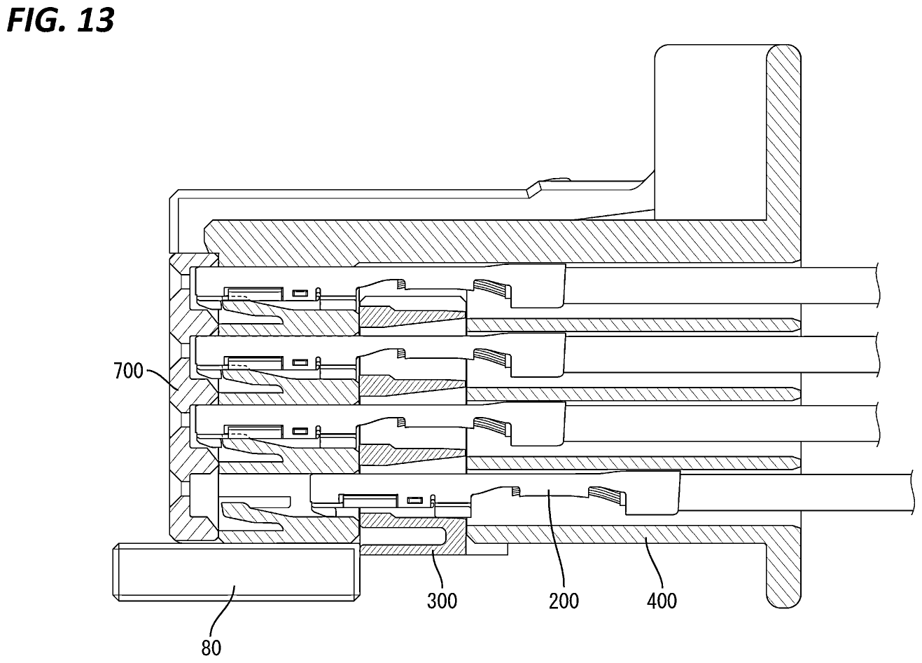

FIG. 14 is a side view in section showing a state where the moving inspection slider does not interfere with the projecting part of the retainer body and the terminal incomplete insertion detection cannot be performed in a second reference example.

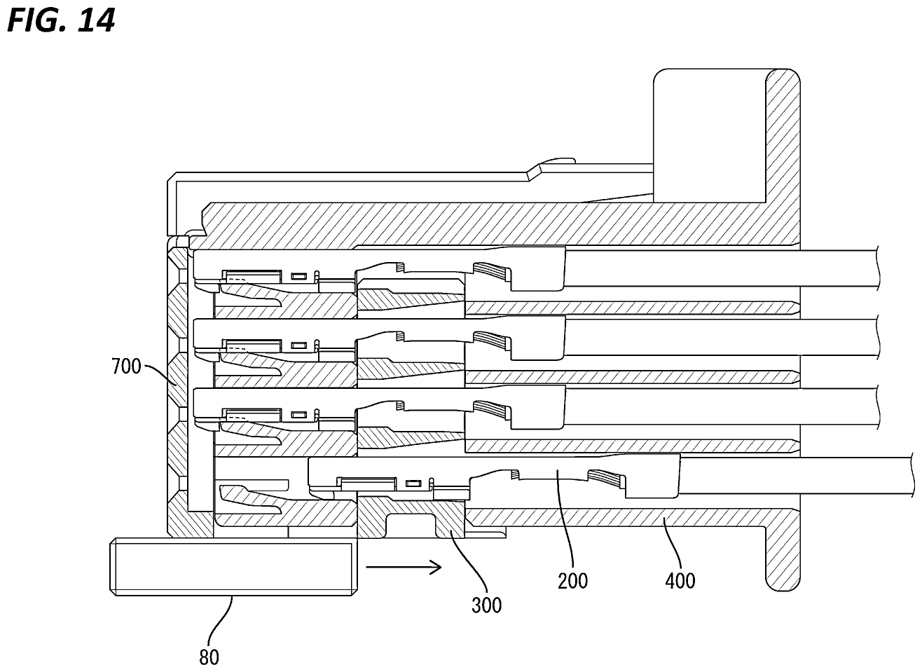

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The connector of the present disclosure is provided with a terminal fitting to be connected to an end part of a wire, a housing for accommodating the terminal fitting and a retainer to be arranged movably between a temporary locking position and a complete locking position with respect to the housing, the housing including a front surface portion facing forward, an end surface portion arranged to intersect the front surface portion and a body mounting portion extending inside the housing and open in the end surface portion, the retainer including a retainer body to be arranged inside the body mounting portion, a front mask portion to be arranged to cover the front surface portion and a coupling portion coupling the retainer body and the front mask portion, the retainer body including a body end part having a projection amount from the end surface portion reduced from the temporary locking position to the complete locking position and a retaining portion for locking the terminal fitting at the complete locking position, the body end part being arranged inside the housing at the complete locking position, and the front mask portion including a recess for allowing a front surface of the body end part to be open forward at the temporary locking position or a halfway position between the temporary locking position and the complete locking position.

If the terminal fitting is left at an incompletely inserted position without being inserted to a specified position into the housing, the retainer interferes with the terminal fitting and a movement of the retainer from the temporary locking position to the complete locking position is hindered. That is, the retainer is left at the temporary locking position or the halfway position with respect to the housing. When the retainer is at the temporary locking position or the halfway position, the body end part of the retainer body projects from the end surface portion of the housing. An inspection slider configured to move along the end surface portion of the housing from the recess of the front mask portion can be brought into contact with the front surface of this body end part. Therefore, even in the connector provided with the front mask integrated retainer in which the retainer body and the front mask portion are integrated, the inspection slider can be brought into contact with the retainer body and terminal incomplete insertion detection by the inspection slider can be performed when the terminal fitting is incompletely inserted.

(2) Preferably, in the connector of (1) described above, the housing includes a pair of side surface portions intersecting each of the front surface portion and the end surface portion while facing in a width direction, the coupling portion includes a pair of side walls for covering the pair of side surface portions, and the end surface portion is exposed to a space portion formed between the pair of side walls.

Since the front surface of the body end part is open forward through the recess from the space portion formed between the respective side walls, the interference of the inspection slider and the coupling portion can be avoided in performing the terminal incomplete insertion detection.

(3) Preferably, in the connector of (1) or (2) described above, an inner bottom surface of the recess and the end surface portion are arranged in a front-rear direction without any step when the retainer body interferes with the terminal fitting being inserted into the housing at the halfway position.

According to the configuration of (3) described above, the inspection slider can move from the inner bottom surface of the recess to the end surface portion.

(4) Preferably, in the connector of any one of (1) to (3) described above, the housing includes a cavity for accommodating the terminal fitting, the cavity is open in the front surface portion, and a part of the front surface portion is arranged to be exposed inside the recess when the retainer body is at the complete locking position.

When the retainer body is at the complete locking position, it can be detected that the retainer is at the complete locking position by confirming an exposed state of a part of the front mask portion through the recess.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

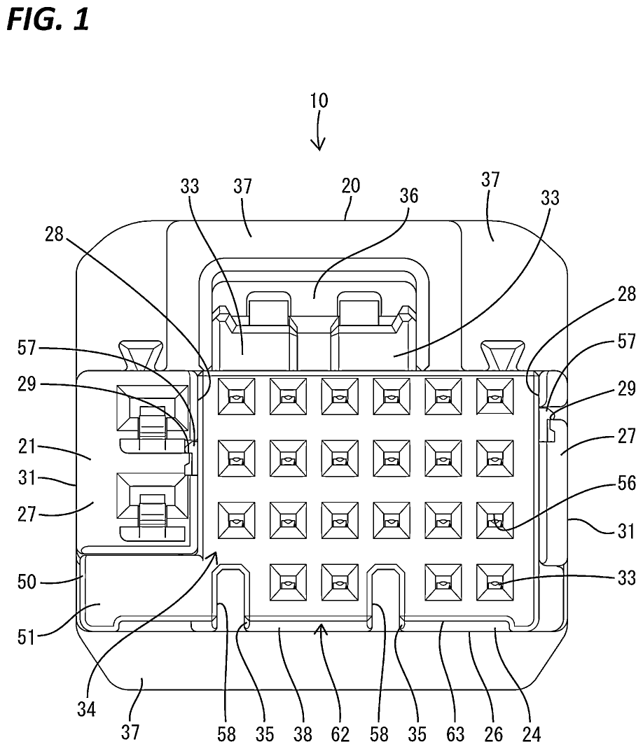

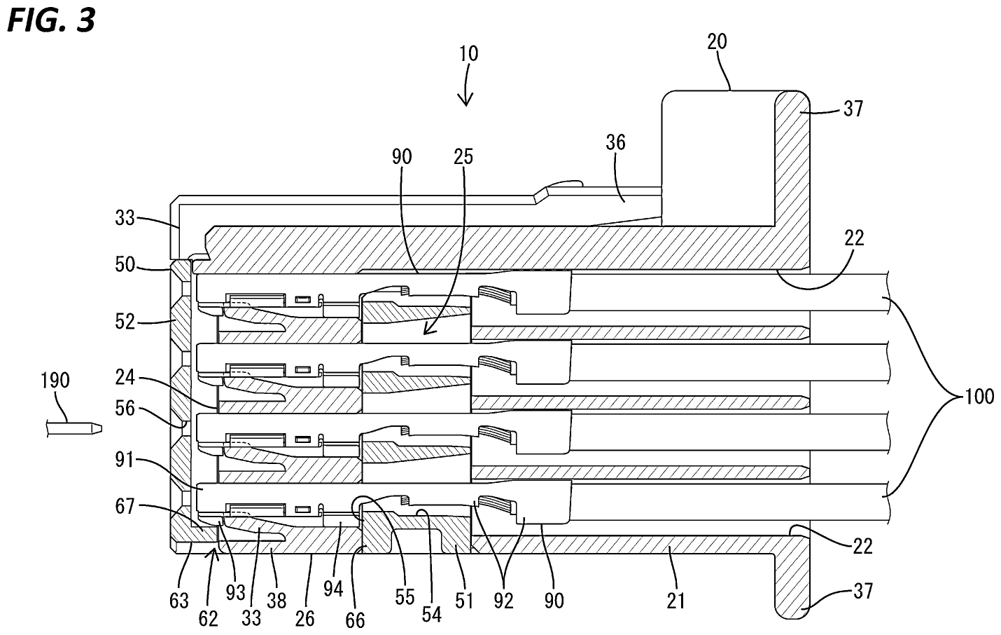

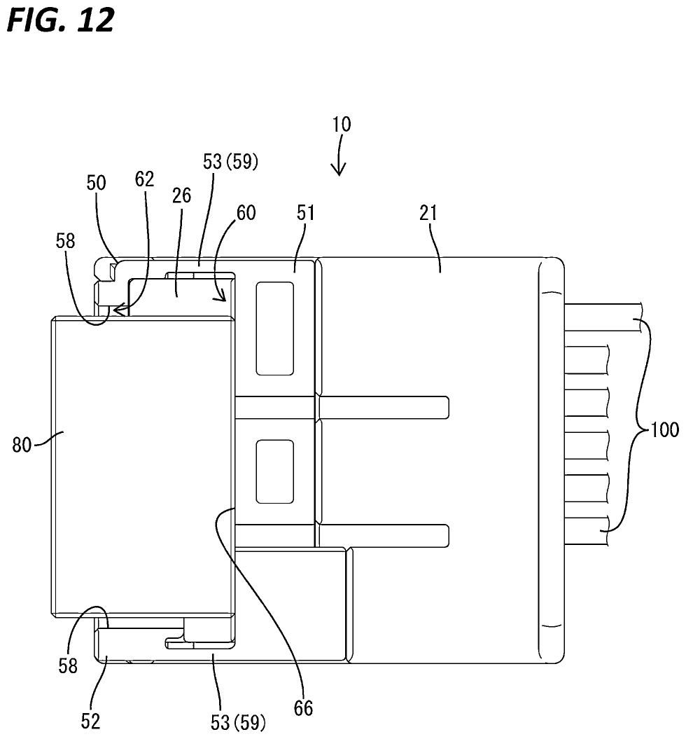

A connector 10 according to one embodiment is, as shown in FIG. 3, provided with a housing 20, terminal fittings 90 to be accommodated into the housing 20 and a retainer 50 to be mounted into the housing 20. The housing 20 is connectable to an unillustrated mating housing. Note that, in the following description, a surface side of the housing 20 facing the mating housing at the time of connection is referred to as a front side concerning a front-rear direction. A vertical direction is based on a vertical direction of each figure except FIG. 12. A lateral direction is a direction intersecting the front-rear direction and vertical direction, and based on a lateral direction of FIG. 1. These directions do not necessarily coincide with direction references in a state where the connector 10 is installed in a vehicle or the like.

### (Housing and Terminal Fittings)

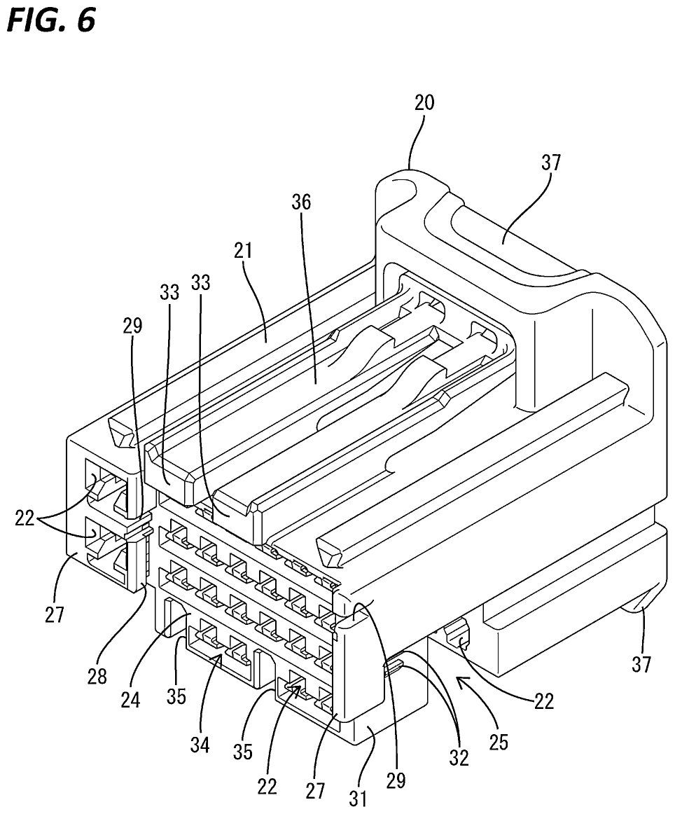

The housing 20 is made of synthetic resin and includes, as shown in FIG. 6, a housing body 21 having a rectangular block-like outer shape. As shown in FIG. 3, the housing body 21 includes a plurality of cavities 22. Each cavity 22 extends in the front-rear direction and is open in the front and rear surfaces of the housing body 21. The front surface of the housing body 21 is constituted as a front surface portion 24 to be covered by a later-described front mask portion 52 of the retainer 50. The terminal fitting 90 is inserted into the corresponding cavity 22 from behind the housing 20.

The housing body 21 includes resiliently deformable locking lances 23 projecting from the lower surfaces of the inner walls of the respective cavities 22. The locking lance 23 is exposed to the front surface portion 24. The terminal fitting 90 is accommodated while being restricted from coming out from the cavity 22 by being locked by the locking lance 23.

The terminal fitting 90 is formed, such as by bending an electrically conductive metal plate material. As shown in FIG. 3, the terminal fitting 90 includes a tubular connecting portion 91 and a barrel portion 92 arranged behind the connecting portion 91. The connecting portion 91 receives a tab 190 of a mating terminal fitting of an unillustrated mating connector and is electrically connected to the mating terminal fitting when the connector 10 is connected. The locking lance 23 is locked to a first projection 93 formed on the lower surface of the connecting portion 91. A second projection 94 projects behind the first projection 93 on the connecting portion 91. The rear end of the second projection 94 is located at the rear end of the connecting portion 91 and can contact a retaining portion 55 of the retainer 50 to be described later. The barrel portion 92 is electrically and mechanically connected to an end part of a wire 100. Note that the wire 100 is a coated wire in which a conductor such as a core wire is covered with an insulation coating.

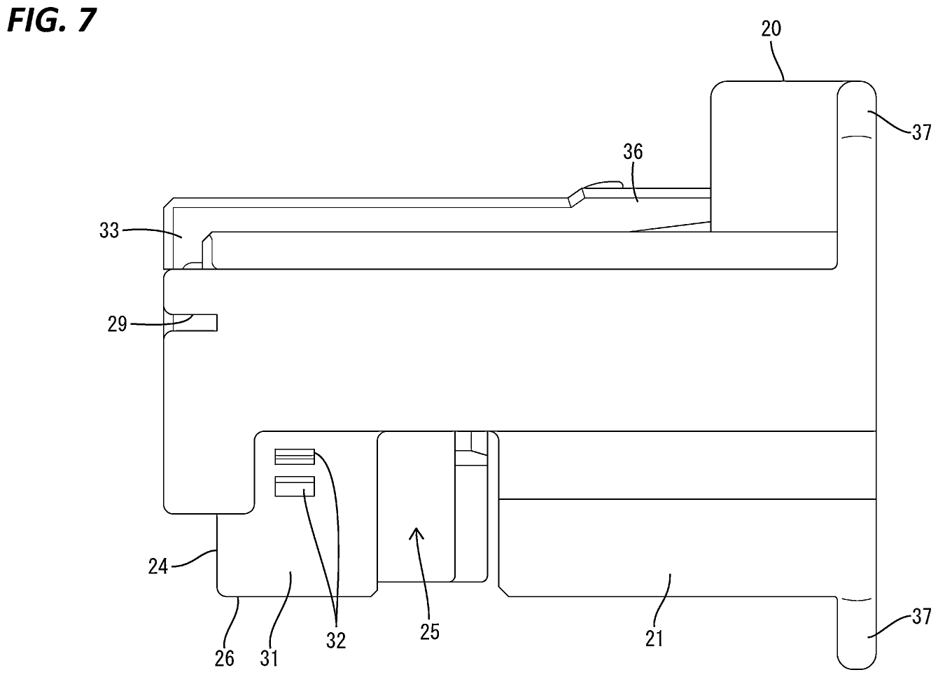

As shown in FIGS. 3 and 6, the housing body 21 includes a body mounting portion 25 extending in the vertical direction and open in the lower surface of the housing body 21 at a halfway position in the front-rear direction. The body mounting portion 25 communicates with each cavity 22. The later-described retainer body 51 of the retainer 50 is arranged inside the body mounting portion 25. As shown in FIGS. 3 and 7, the lower surface of the housing body 21 includes an end surface portion 26 intersecting and connected to the front surface portion 24 in front of an opening of the body mounting portion 25. The end surface portion 26 is a horizontal surface along the front-rear direction and lateral direction and arranged between the front surface portion 24 and the body mounting portion 25.

As shown in FIGS. 1 and 6, the housing body 21 includes partition portions 27 projecting forward from both left and right end parts of the front surface portion 24. The respective partition portions 27 have inner side surfaces 28 facing parallel to each other. The inner side surface 28 of each partition portion 27 is arranged along the vertical direction. The housing body 21 includes second lock receiving portions 29 open in the inner side surfaces 28 of the respective partition portions 27. The second lock receiving portion 29 is open forward of the housing body 21.

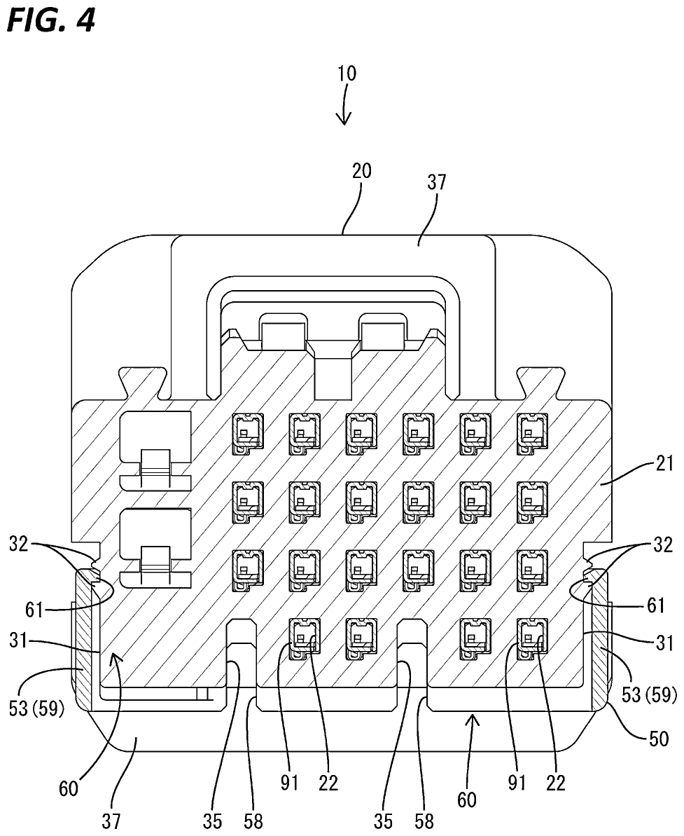

As shown in FIGS. 4 and 7, the housing body 21 includes a pair of side surface portions 31 intersecting each of the front surface portion 24 and the end surface portion 26 on both left and right side end surfaces. The housing body 21 includes rib-like first lock receiving portions 32 extending in the front-rear direction on each side surface portion 31. A pair of the first lock receiving portions 32 are arranged on each side surface portion 31 while being spaced apart in the vertical direction.

As shown in FIGS. 1 and 6, bridge portions 33 are provided between upper end parts of the respective partition portions 27. The housing body 21 includes a mask mounting portion 34 between the inner side surfaces 28 of the respective partition portions 27 and below the bridge portions 33. The mask mounting portion 34 is open forward of the housing body 21. The later-described front mask portion 52 of the retainer 50 is arranged inside the mask mounting portion 34. The housing body 21 includes a pair of housing grooves 35 open on both left and right sides of a lower end part of the front surface portion 24. Each housing groove 35 is open from the front surface portion 24 to the end surface portion 26.

Further, the housing 20 includes a lock arm 36 projecting from the upper surface of the housing body 21 and protruding portions 37 respectively protruding upward and downward from a rear end part of the housing body 21.

The lock arm 36 extends from a front end part connected to the bridge portions 33 to a rear end part and is resiliently deformable in the vertical direction with the front end part as a fulcrum. The lock arm 36 locks the unillustrated mating housing, and holds the housing 20 and the mating housing in a connected state. Each protruding portion 37 is wall-like and arranged with wall surfaces facing forward and rearward. The upper protruding portion 37 surrounds the outer periphery of the rear end part of the lock arm 36. A worker can connect and separate the connector 10 while pinching the respective protruding portions 37.

### (Retainer)

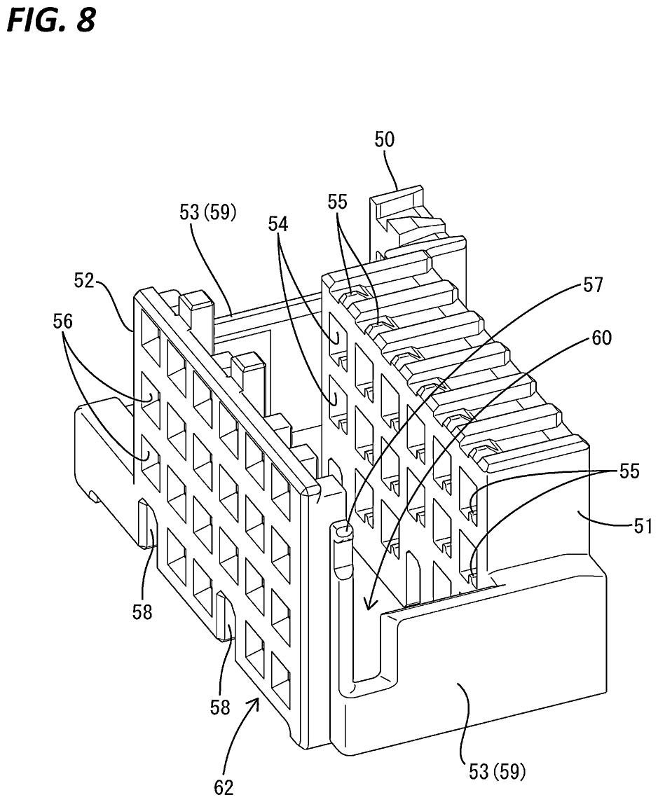

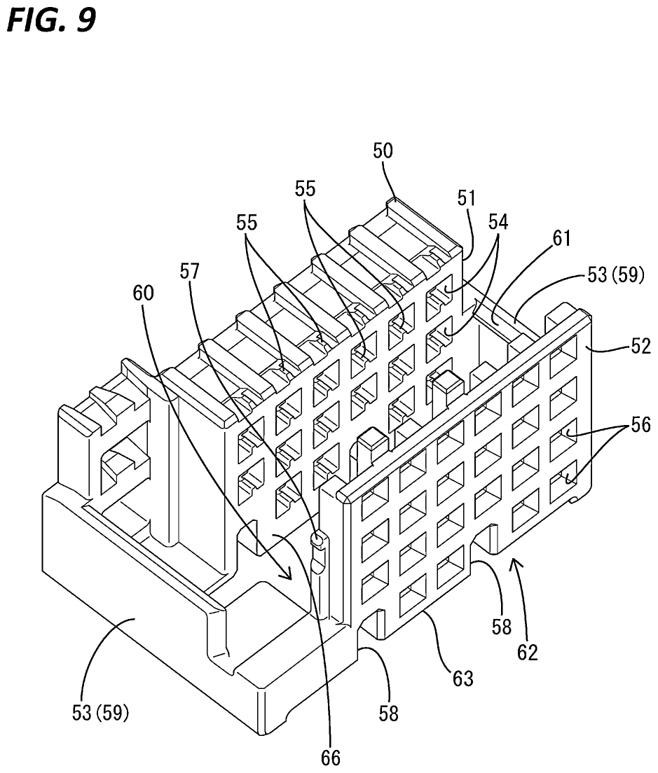

The retainer 50 is made of synthetic resin and includes, as shown in FIGS. 8 and 9, the retainer body 51, the front mask portion 52 arranged in front of the retainer body 51 to face the retainer body 51, and a coupling portion 53 coupling the retainer body 51 and the front mask portion 52. The retainer body 51 and the front mask portion 52 maintain a constant positional relationship thereof by the coupling portion 53.

The retainer body 51 has a rectangular block-like outer shape and is fittable into the body mounting portion 25 (see FIG. 3). The retainer body 51 includes a plurality of through holes 54 penetrating in the front-rear direction. When the retainer body 51 is arranged inside the body mounting portion 25, the respective through holes 54 communicate with the respective cavities 22 except those in the uppermost stage. The retainer body 51 includes rib-like retaining portions 55 projecting from the lower surfaces of the inner walls of the respective through holes 54. Each retaining portion 55 is formed for each through hole 54. Further, the retaining portions 55 are also formed side by side at positions corresponding to the cavities 22 in the uppermost stage on the upper surface of the retainer body 51.

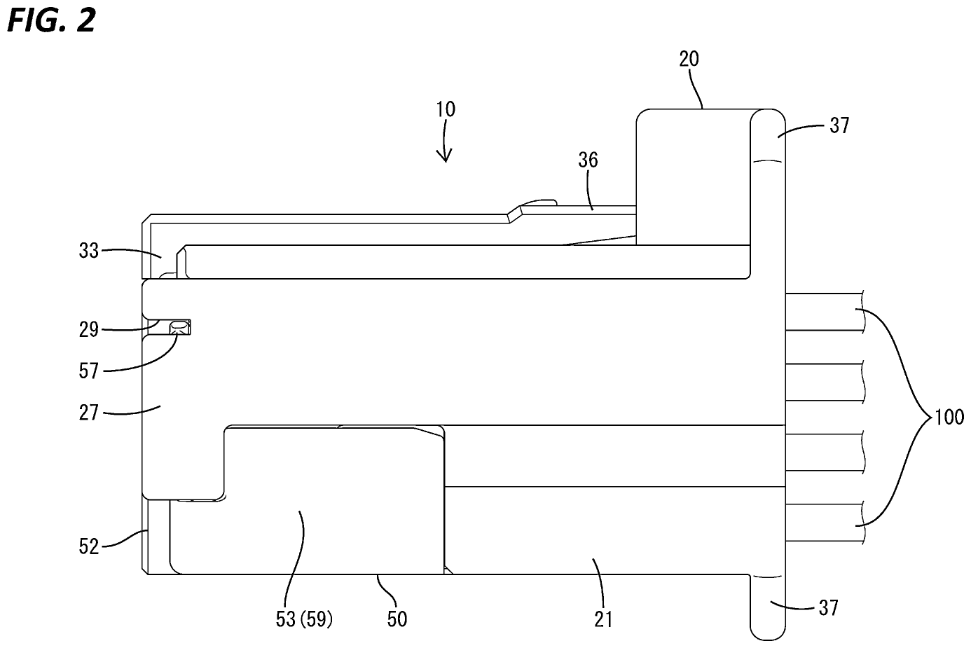

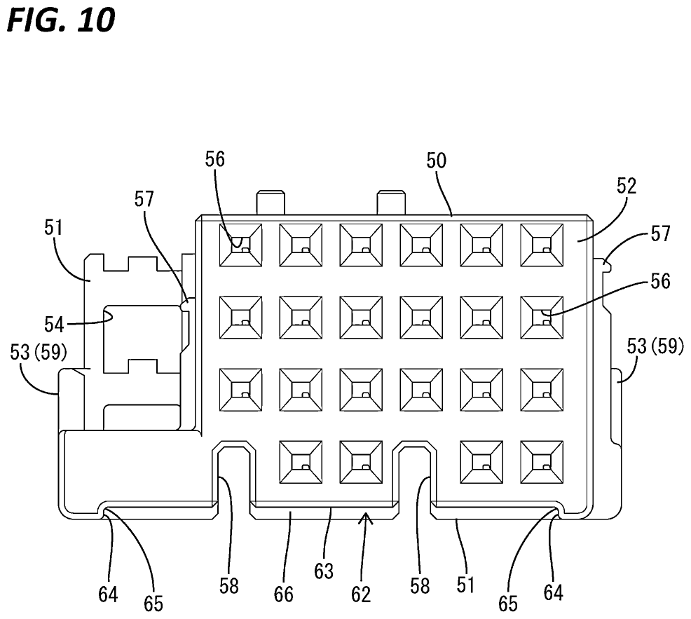

The front mask portion 52 is in the form of a rectangular plate and arranged with plate surfaces facing forward and rearward. As shown in FIGS. 8 to 10, the front mask portion 52 includes a plurality of tab insertion holes 56 penetrating in the front-rear direction. When the front mask portion 52 is arranged to cover the front surface portion 24, the respective tab insertion holes 56 communicate with the respective cavities 22 (see FIG. 3). When the connector 10 is connected, the tabs 190 of the mating terminal fittings are inserted into the tab insertion holes 56. As shown in FIG. 10, the front mask portion 52 includes second locking portions 57 projecting from end surfaces on both left and right sides. The second locking portions 57 are lockable to the second lock receiving portions 29 (see FIGS. 1 and 2).

The front mask portion 52 includes a pair of retainer grooves 58 penetrating in the front-rear direction on both left and right sides of a lower end part. Each retainer groove 58 is open in an inner bottom surface 63 of a later-described recess 62 of the front mask portion 52. When the front mask portion 52 is arranged to cover the front surface portion 24, the respective retainer grooves 58 communicate with the respective housing grooves 35 as shown in FIG. 1. A rib of the unillustrated mating housing is fit into each retainer groove 58 and each housing groove 35 when the connector 10 is connected. If the housing 20 is in an improper connection posture with respect to the mating housing, the fitting of the ribs into the retainer grooves 58 and the housing grooves 35 is restricted. In this way, erroneous connection of the connector 10 is prevented.

As shown in FIGS. 8 to 10, the coupling portions 53 are constituted by a pair of side walls 59 arranged at an interval in the lateral direction. Each side wall 59 is wall-like and arranged with wall surfaces facing in the lateral direction. Front end parts of the respective side walls 59 are coupled to the end surfaces on the both left and right sides of the front mask portion 52. Rear end parts of the respective side walls 59 are coupled to end surfaces on both left and right sides of the retainer body 51. A space portion 60 penetrating in the vertical direction is formed between the retainer body 51 and the front mask portion 52 and between the respective side walls 59 (see FIG. 9). When the retainer 50 is mounted into the housing 20, the end surface portion 26 is arranged to be exposed to the space portion 60 as shown in FIG. 12. As shown in FIG. 4, the respective side walls 59 include first locking portions 61 projecting into the space portion 60 from inner surfaces facing each other. The first locking portions 61 are lockable to the first lock receiving portions 32.

The retainer 50 is arranged movably between a temporary locking position and a complete locking position with respect to the housing 20. At the temporary locking position, the first locking portions 61 are fit between the upper and lower first lock receiving portions 32 (see FIG. 4) and the first locking portions 61 are arranged below the upper first lock receiving portions 32. In this way, the retainer 50 is held with a movement to the temporary locking position with respect to the housing 20 restricted. At the complete locking position, the first locking portions 61 are arranged above the upper first lock receiving portions 32 and the second locking portions 57 are fit in the second lock receiving portions 29 (see FIG. 1). In this way, at the complete locking position where the retainer 50 is held with a movement to the temporary locking position with respect to the housing 20 restricted, the upper end of the front mask portion 52 is stopped in contact with the bridge portions 33 and an upward movement of the retainer 50 further than the complete locking position is reliably restricted.

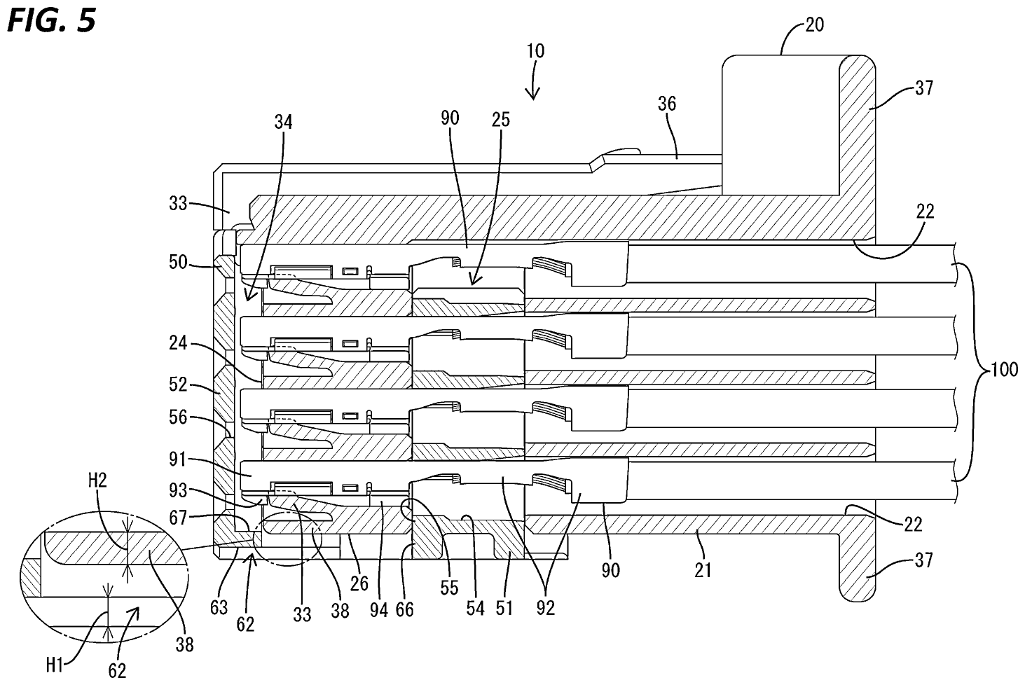

As shown in FIG. 10, the retainer 50 includes the recess 62 recessed from the lower surface of the front mask portion 52. The recess 62 penetrates through the lower end part of the front mask portion 52 in the front-rear direction except both left and right end parts, and is open in the front and rear surfaces of the front mask portion 52 in addition to the lower surface of the front mask portion 52. Specifically, the recess 62 is defined by the inner bottom surface 63 extending long in the lateral direction in a lateral central part of the front mask portion 52, a pair of inner end surfaces 64 extending short in the vertical direction on the both left and right end parts of the front mask portion 52 and right-angled or curved inner corner parts 65 located between the upper ends of the respective inner end surfaces 64 and the left and right ends of the inner bottom surface 63. A width in the lateral direction of the recess 62 is more than half the entire width in the lateral direction of the front mask portion 52. A depth (height H1) in the vertical direction of the recess 62 is set to be equal to or smaller than a thickness H2 (see FIG. 5) of a cavity bottom part 38 formed between the cavities 22 in the lowermost stage and the end surface portion 26 in the housing 20 (H1≤H2). Further, the depth (height H1) in the vertical direction of the recess 62 is set to be equal to or smaller than a movement amount of the retainer 50 moving from the temporary locking position to the complete locking position.

As shown in FIG. 10, the retainer body 51 includes a body end part 66 in a lower end part having the same height range as the recess 62 in the vertical direction. The front surface of the body end part 66 is open forward from the recess 62 and arranged to be visually confirmable from front.

### (Functions of Connector)

As shown in FIG. 3, when the retainer 50 is held at the temporary locking position with respect to the housing 20, the terminal fittings 90 are inserted into the cavities 22 of the housing 20. The terminal fitting 90 is connected to the end part of the wire 100 in advance. If the terminal fitting 90 is properly inserted to a specified position into the cavity 22, the first projection 93 of the connecting portion 91 is arranged to be lockable by the locking lance 23. In this way, the terminal fitting 90 is arranged while being primarily restricted from coming out from the cavity 22.

When the retainer 50 is at the temporary locking position, the front mask portion 52 is arranged inside the mask mounting portion 34. The first projection 93 of the terminal fitting 90 inserted into the cavity 22 in the lowermost stage is arranged away from a mask bottom part 67 located above the recess 62. The terminal fitting 90 is restricted from moving any further forward by contacting the front mask portion 52. Further, when the retainer 50 is at the temporary locking position, the retainer body 51 is arranged inside the body mounting portion 25 and the retaining portions 55 are retracted from the cavities 22. In this way, the insertion of the terminal fittings 90 into the cavities 22 is allowed.

The recess 62 of the front mask portion 52 and the body end part 66 of the retainer body 51 are arranged below the end surface portion 26 at the temporary locking position. The front surface of the body end part 66 is open forward from the recess 62 at the temporary locking position and arranged to be visually confirmable from front.

After the terminal fittings 90 are inserted into the cavities 22, the retainer 50 is moved from the temporary locking position to the complete locking position. If an upward pushing force is applied to the retainer 50, the locking of the first lock receiving portions 32 and the first locking portions 61 is released, the locking of the second lock receiving portions 29 and the second lock receiving portions 57 is released and the retainer 50 becomes movable to the complete locking position.

If the retainer 50 reaches the complete locking position, the retaining portions 55 are arranged to be lockable to the second projections 94 of the connecting portions 91 as shown in FIG. 3. In this way, the terminal fittings 90 are secondarily restricted from coming out. A projection amount of the body end part 66 of the retainer body 51 from the end surface portion 26 is reduced in the process of moving from the temporary locking position to the complete locking position, and the body end part 66 is entirely accommodated in the body mounting portion 25 at the complete locking position.

When the retainer 50 is at the complete locking position, the cavity bottom part 38 enters the space portion 60 and the lower surface of the retainer body 51 and the end surface portion 26 are arranged at the same height position. The inner bottom surface 63 of the recess 62 is arranged at the same height position as the upper end of the cavity bottom part 38. As shown in FIG. 1, the lower end part of the front surface portion 24 (including the front surface of the cavity bottom part 38) is open forward from the recess 62 and arranged to be visually confirmable from front. As shown in FIG. 3, the cavities 22 in the lowermost stage are arranged away from the recess 62 without communicating with the recess 62 even at the complete locking position. The mask bottom part 67 is arranged forward of the locking lances 23 projecting from the cavities 22 in the lowermost stage.

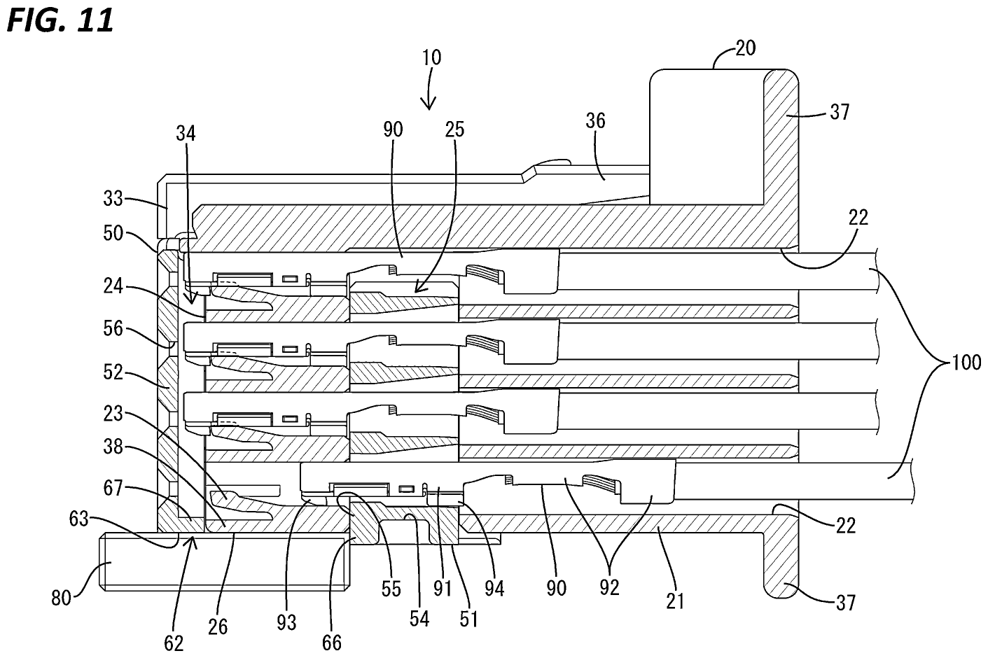

In contrast, if the terminal fitting 90 is left at an incompletely inserted position without being inserted to the specified position into the cavity 22 as shown in FIG. 11, the inner surface of the through hole 54 of the retainer body 51 and the like interfere with the second projection 94 and the like of the connecting portion 91 at a halfway position while the retainer 50 is moving from the temporary locking position to the complete locking position. In this way, a movement of the retainer 50 to the complete locking position is restricted. Note that although a case where one terminal fitting 90 inserted into the cavity 22 in the lowermost stage is left at the incompletely inserted position is shown in FIG. 11, a movement of the retainer 50 to the complete locking position is similarly restricted also when the other terminal fittings 90 are left at an incompletely inserted position.

As shown in FIG. 11, the inner bottom surface 63 of the recess 62 is arranged at the same height position as the end surface portion 26 at a halfway position. A part from the inner bottom surface 63 of the recess 62 to the end surface portion 26 is continuously arranged in the front-rear direction. The mask bottom part 67 and the cavity bottom part 38 are arranged side by side in the front-rear direction in the same height range.

The body end part 66 projects from the end surface portion 26 also at the halfway position. The front surface of the body end part 66 is exposed forward from the recess 62 and arranged to be visually confirmable from front.

After a moving operation of the retainer 50, whether or not there is any terminal fitting 90 left at the incompletely inserted position in the cavity 22 is inspected. In performing inspection, an inspection slider 80 shown in FIG. 11 is used. The inspection slider 80 is set to linearly move rearward along the end surface portion 26 from the front of the housing 20. Specifically, the inspection slider 80 is in the form of a horizontal plate and set to parallelly move along the end surface portion 26 at a certain height position. Note that, since the lower protruding portion 37 is provided on the rear end part of the housing 20 in the case of this embodiment, the inspection slider 80 cannot be moved from behind the housing 20.

The inspection slider 80 enters the recess 62 from front and moves in the part from the inner bottom surface 63 of the recess 62 to the end surface portion 26. Here, if the terminal fittings 90 are inserted to the specified positions in the cavities 22, the retainer 50 can reach the complete locking position and the lower surface of the retainer body 51 and the end surface portion 26 are continuous at the same height position. Thus, the inspection slider 80 can directly move rearward along the lower surface of the retainer body 51 from the end surface portion 26.

On the other hand, if the terminal fitting 90 is left at the incompletely inserted position in the cavity 22, the body end part 66 of the retainer body 51 projects from the end surface portion 26 as described above. Thus, the rear end surface (tip surface in a moving direction) of the inspection slider 80 butts against the front surface of the body end part 66. In this way, a movement of the inspection slider 80 is restricted. As just described, it is understood that the retainer 50 is at a halfway position and the terminal fitting 90 is left at the incompletely inserted position in the cavity 22 if the movement of the inspection slider 80 is restricted. That is, it can be indirectly detected that the terminal fitting 90 is at the incompletely inserted position (hereinafter, referred to as “terminal incomplete insertion detection by the inspection slider 80”) by a detection method using the inspection slider 80.

As described above, in the case of this embodiment, the retainer 50 is a front mask integrated retainer in which the front mask portion 52 and the retainer body 51 are coupled by the coupling portion 53. The retainer body 51 includes the body end part 66 having the projection amount from the end surface portion 26 of the housing 20 reduced from the temporary locking position to the complete locking position. The front mask portion 52 includes the recess 62 for allowing the front surface of the body end part 66 to be open forward at the temporary locking position and a halfway position between the temporary locking position and the complete locking position. If the retainer 50 interferes with the terminal fitting 90 and stops at the halfway position when the terminal fitting 90 is left at the incompletely inserted position, the body end part 66 of the retainer body 51 projects from the end surface portion 26 and the inspection slider 80 moving from the recess 62 along the end surface portion 26 can be brought into contact with the front surface of that body end part 66. Thus, even in the connector 10 provided with the front mask integrated retainer 50, the inspection slider 80 can be brought into contact with the retainer body 51 when the terminal fitting 90 is incompletely inserted, and the terminal incomplete insertion detection by the inspection slider 80 can be performed.

Further, in the case of this embodiment, the end surface portion 26 of the housing 20 is exposed to the space 60 formed between the respective side walls 59 of the coupling portion 53 and the front surface of the body end part 66 is exposed forward through the recess 62 from the space portion 60. Thus, when the terminal incomplete insertion detection by the inspection slider 80 is performed, the interference of the inspection slider 80 with the coupling portion 53 can be easily avoided.

Further, when the terminal fitting 90 is incompletely inserted and the retainer body 51 is at the halfway position, the inner bottom surface 63 of the recess 62 and the end surface portion 26 are arranged in the front-rear direction without any step as shown in FIG. 11 and the inspection slider 80 can move from the inner bottom surface 63 of the recess 62 to the end surface portion 26.

Further, since a part of the front surface portion 24 of the housing 20 is exposed to the inside of the recess 62 when the retainer 50 is at the complete locking position, it is also possible to confirm an exposed state of the front surface portion 24 through the recess 62 and detect that the retainer 50 is at the complete locking position.

### Other Embodiments of Present Disclosure

The embodiment disclosed this time should be considered illustrative in all aspects, rather than restrictive.

In the case of the above embodiment, the retainer 50 is provided with the first locking portions and the second locking portions and the housing is provided with the first lock receiving portions and the second lock receiving portions as a means for holding the retainer in the housing. In contrast, in the case of another embodiment, a retainer may be provided with only first locking portions and a housing may be provided with only first lock receiving portions as a means for holding the housing.

In the case of the above embodiment, the recess is provided in the lower end part of the front mask portion except the both left and right end parts. In contrast, in the case of another embodiment, a recess may be provided over an entire width in a lateral direction of a lower end part of a front mask portion. Alternatively, a plurality of recesses may be provided at intervals in a lateral direction in a lower end part of a front mask portion.

In the case of the above embodiment, the inner bottom surface of the recess and the front surface portion are arranged in the front-rear direction without any step when the terminal fitting is incompletely inserted and the retainer is at the halfway position. In contrast, in the case of another embodiment, an inner bottom surface of a recess may be arranged above an end surface portion via a step when a terminal fitting is incompletely inserted and a retainer is at a halfway position.

The recess of the front mask portion allows the front surface of the body end part to be open forward at the temporary locking position. The interference of the retainer with the terminal fitting at the incompletely inserted position when the retainer is at the temporary locking position is within an envisioned range of the present disclosure.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal fitting to be connected to an end part of a wire;
a housing for accommodating the terminal fitting; and
a retainer to be arranged movably between a temporary locking position and a complete locking position with respect to the housing,
the housing including a front surface portion facing forward, an end surface portion arranged to intersect the front surface portion and a body mounting portion extending inside the housing and open in the end surface portion,
the retainer including a retainer body to be arranged inside the body mounting portion, a front mask portion to be arranged to cover the front surface portion and a coupling portion coupling the retainer body and the front mask portion,
the retainer body including a body end part having a projection amount from the end surface portion reduced from the temporary locking position to the complete locking position and a retaining portion for locking the terminal fitting at the complete locking position,
the body end part being arranged inside the housing at the complete locking position, and
the front mask portion including a recess for allowing a front surface of the body end part to be open forward at the temporary locking position or a halfway position between the temporary locking position and the complete locking position.

2. The connector of claim 1, wherein:
the housing includes a pair of side surface portions intersecting each of the front surface portion and the end surface portion while facing in a width direction,
the coupling portion includes a pair of side walls for covering the pair of side surface portions, and
the end surface portion is exposed to a space portion formed between the pair of side walls.

3. The connector of claim 1, wherein an inner bottom surface of the recess and the end surface portion are arranged in a front-rear direction without any step when the retainer body interferes with the terminal fitting being inserted into the housing at the halfway position.

4. The connector of claim 1, wherein:
the housing includes a cavity for accommodating the terminal fitting,
the cavity is open in the front surface portion, and
a part of the front surface portion is arranged to be exposed inside the recess when the retainer body is at the complete locking position.
